(19) United States
(12) Patent Application Publication
(10) Pub. No.: US 2012/0242187 A1
(43) Pub. Date: Sep. 27, 2012

(54) ROTOR HUB KEYWAY AND RETAINED KEY ASSEMBLY

(75) Inventors: Timothy J. Reinhart, Brownsburg, IN (US); Joel E. Mowatt, Zionsville, IN (US); Frederick W. Rhoads, Holly, MI (US)

(73) Assignee: GM GLOBAL TECHNOLOGY OPERATIONS LLC, Detroit, MI (US)

(21) Appl. No.: 13/069,467

(22) Filed: Mar. 23, 2011

(51) Int. Cl. H02K 1/28; H02K 15/02

(52) U.S. Cl. 310/216.123; 29/598

(57) ABSTRACT

An electric motor comprises a rotor hub defining a first slot and a rotor stack defining a second slot. A rotor key has a shape corresponding to the cross-sectional shape of the first slot such that the rotor key is removably retained within the first slot. The rotor key is inserted into the first slot on the rotor hub and the second slot on the rotor stack.

### TECHNICAL FIELD

The present invention relates, generally, to a rotor assembly for an electric motor assembly.

### BACKGROUND OF THE INVENTION

Electric motors include rotor assemblies which have a rotor stack formed from magnets and laminated layers of discs stacked together. The rotor stack is assembled on a rotor hub for stability within an electric motor. The rotor stack and the rotor hub rotate together as an assembly relative to the stator for the electric motor. Therefore, to ensure optimal operation of the electric motor, the rotor stack must be rotationally aligned with the rotor hub at the time of assembly.

The rotor hub and the rotor stack are typically aligned by broaching a rotor key on the laminates that form the rotor stack. The key is inserted into a keyway on the rotor hub when the rotor hub and rotor stack are assembled together. The rotor key and keyway ensure rotational alignment and prevent relative rotation between the rotor hub and the rotor stack. However, the rotor stack requires a skewing progress for the magnets and the laminate layers that form the stack which makes forming the key on to the laminate layers difficult.

### SUMMARY OF THE INVENTION

An electric motor comprises a rotor hub defining a first slot and a rotor stack defining a second slot. A rotor key has a shape corresponding to the cross-sectional shape of the first slot such that the rotor key is removably retained within the first slot. The rotor key is inserted into the first slot on the rotor hub and the second slot on the rotor stack.

A rotor assembly comprises a rotor hub defining a first slot having a generally dovetail cross-sectional shape. A rotor key has a shape corresponding to the generally dovetail cross-sectional shape of the first slot. The rotor key is inserted into the first slot on the rotor hub.

A method of assembling a rotor assembly comprises inserting a rotor key having a trapezoidal shape in a first slot defined by a rotor hub, wherein the first slot has a dovetail shape corresponding to the shape of the rotor key such that the rotor key is retained within the first slot. A second slot defined by a rotor stack is aligned with the rotor key. The rotor stack is mounted on the rotor hub, such that a portion of the rotor key is received within the second slot.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a partial schematic exploded perspective illustration of an electric motor assembly;

FIG. 2 is a schematic perspective illustration of a rotor hub and key assembly for the electric motor of FIG. 1;

FIG. 3 is a schematic enlarged perspective illustration of a rotor hub and key assembly for the electric motor of FIGS. 1-2;

FIG. 4 is a schematic enlarged top view illustration of a rotor hub and key assembly for the electric motor of FIGS. 1-3;

FIG. 5 is a schematic side illustration of the rotor hub and key assembly for the electric motor of FIGS. 1-4; and

FIG. 6 is a schematic enlarged side illustration of the rotor hub and key assembly for the electric motor of FIGS. 1-5.

### DESCRIPTION OF THE PREFERRED EMBODIMENTS

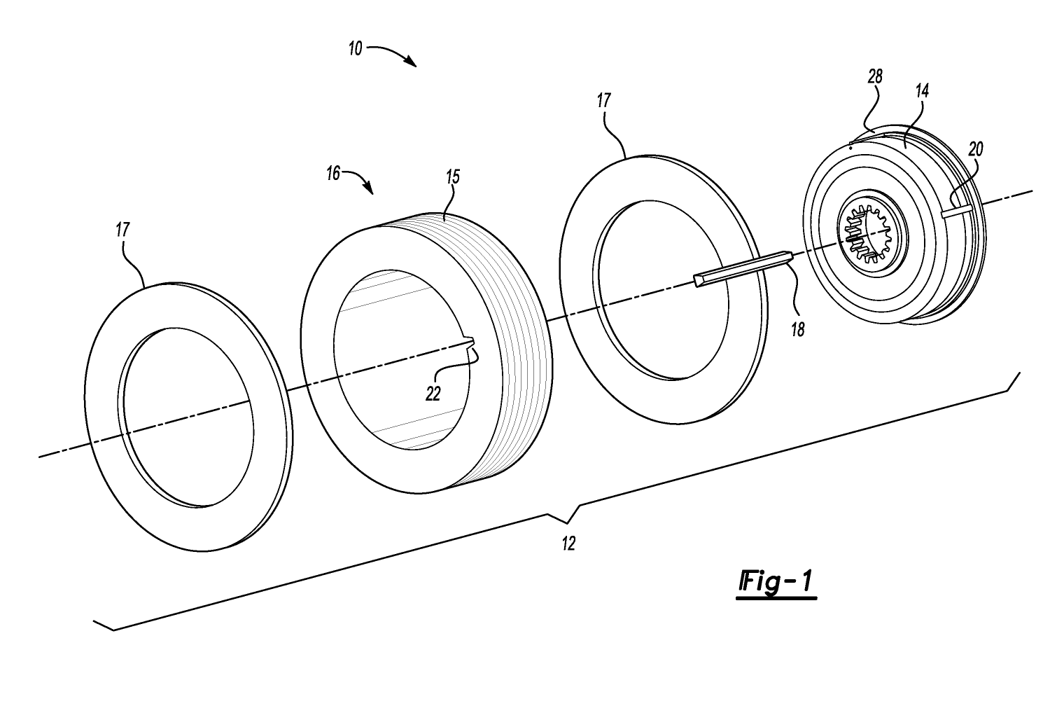

Referring to the Figures, wherein like reference numbers refer to the same or similar components throughout the several views, FIG. 1 schematically illustrates a partial view of an electric motor 10 and a rotor assembly 12 for the electric motor 10. The rotor assembly 12 includes a rotor stack 16 and a rotor hub 14. The rotor stack 16 is formed from a stack of laminate layers 15 each having a generally annular shape. Two end rings 17 are assembled onto the rotor hub 14 on either side of the rotor stack 16. A rotor key 18 is retained within a first slot 20 defined by the rotor hub 14. The rotor key 18 may be inserted into the first slot 20 of the rotor hub 14 during manufacturing of the rotor hub 14. The shape of the first slot 20 formed in the rotor hub 14 and the rotor key 18 may retain the rotor key 18 as explained in further detail below. A second slot 22 may be defined by the rotor stack 16 to align with the rotor key 18 when assembling the rotor assembly 12.

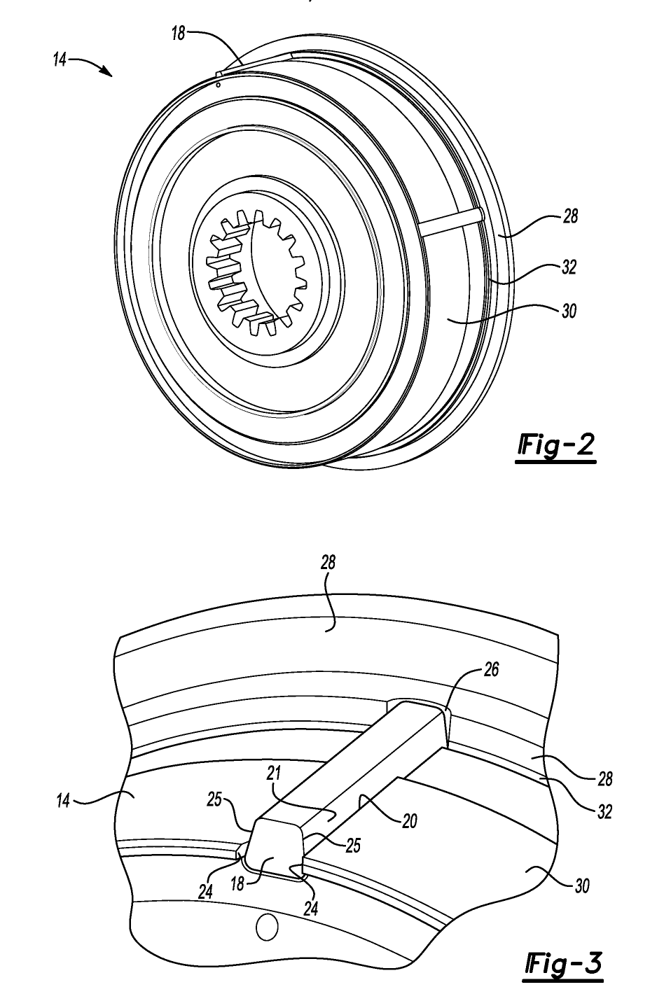

FIG. 2 illustrates a perspective view of the rotor assembly 12. The rotor assembly 12 includes the rotor hub 14. The rotor hub 14 defines the first slot 20. The first slot 20 has a generally dovetail, or trapezoidal, cross-sectional shape. The rotor key 18 has a trapezoidal shape corresponding to the generally dovetail cross-sectional shape of the first slot 20. The rotor key 18 is inserted with the first slot 20 on the rotor hub 18.

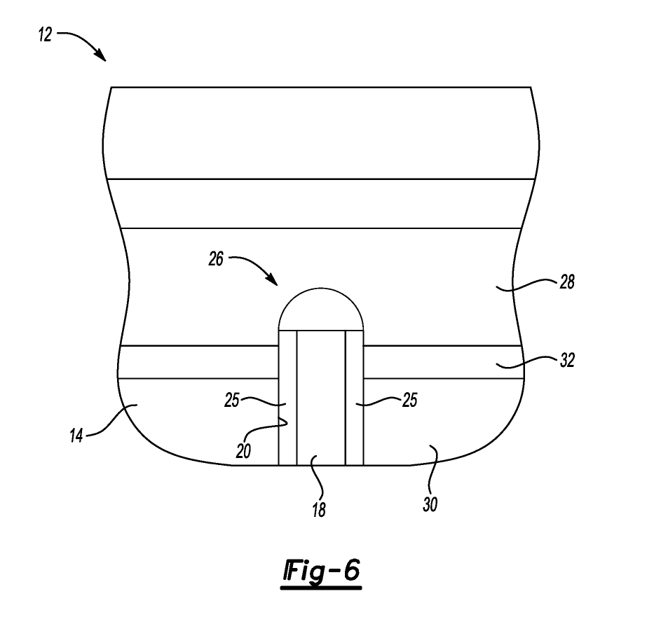

Referring to FIGS. 3-6 the rotor hub 14, rotor key 18 and first slot 20 are shown in greater detail. The first slot 20 is defined by the rotor hub 14 and has a generally dovetail, or trapezoidal shape, shape formed by the rotor hub 14. The rotor hub 14 defines sloping sides 24 of the first slot 20. Likewise, the rotor key has a corresponding trapezoidal shape to interfit with the first slot 20. The rotor key 18 is inserted within the first slot 20 by axially sliding the rotor key 18 into the first slot 20 along a core portion 30 of the rotor hub 14. The rotor key 18 and first slot 20 may have a clearance fit to allow easy assembly of the rotor key 18 within the first slot 20 of the rotor hub 14.

Sloping sides 25 on the rotor key 18 follow the shape of the sloping sides 24 on the hub 14 forming the first slot 20. The sides 24 and 25 assist in retaining the rotor key 18 in the first slot 20. The rotor key 18 is retained in the first slot 20 by the corresponding shapes. Alternative to the dovetail or trapezoidal cross-sectional shape of the first slot 20 and the rotor key 18 both may have a generally rectangular cross-section shape. In either instance, a staking operation may be performed to retain the rotor key 18 within the first slot 20. That is, a small amount of material on the rotor key 18 or rotor hub 14 may be upset to retain the rotor key 18 within the rotor hub 14 prior to assembly of the rotor hub 14 and the rotor stack 16.

Alternatively, the rotor key 18 may be removable from the rotor hub 14 prior to assembly of the rotor stack 16, by axially sliding the rotor key 18 out of the first slot 20. In this manner the rotor key 18 and the rotor hub 14 are partially assembled to remain together prior to assembly of the rotor assembly 12 (shown in FIGS. 1 and 2).

The rotor hub 14 has a base 28 which has a larger outer diameter than the core portion 30 of the rotor hub 14. A relief groove 32 is formed around the outer diameter of the rotor hub 14 between the core portion 30 and the base 28. The groove 32 allows for oil and/or lubricants during operation of the electric motor 10. The first slot 20 is formed in the core portion 30 of the rotor hub 14 and extends past the groove 32 into the base 28. A rounded end 26 of the first slot 20 allows the rotor key 18 to bottom out and rest on the base 28 when the key is assembled with the rotor hub 14. The rotor key 18 may have a corresponding shape or taper to interfit with the bottom of the first slot 20 formed by the rotor hub 14.

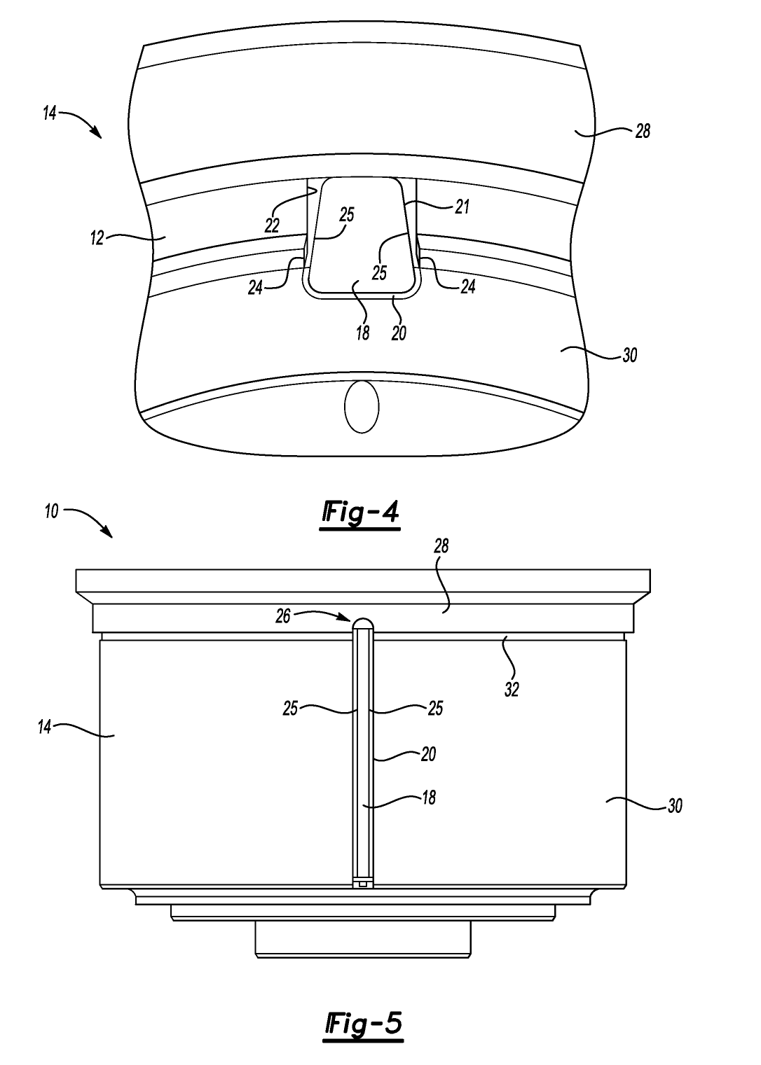

As can be seen in FIG. 4, when the rotor key 18 is assembled on the rotor hub 14 a portion 21 of the rotor key 18 extends radially outward past the core portion 30. The corresponding second slot 22 formed in the rotor stack 16 receives the outwardly extending portion 21 of the rotor key 18. Therefore, the rotor key 18 does not need to be formed by broaching the rotor key 18 on the rotor stack 16. The rotor stack 16 is rotationally positioned such that the second slot 22 is aligned with the rotor key 18.

The rotor stack 16 has a generally annular shape such that the rotor stack may be mounted on the rotor hub 14 by axially moving the rotor stack 16 over the core position 30 of the rotor hub 14. Typically, the rotor stack 16 is press fit onto the rotor hub 14. Similar to the rotor key 18, the rotor stack 16 may be fully seated on the rotor hub 14 when the rotor stack 16 is contacting the end ring 17 which is resting on the base 28 of the rotor hub. Thus, the rotor stack 16 may be assembled on the rotor hub 14 in a manner that allows a portion of the rotor key 18 to be inserted in the second slot 22. The rotor key 18 is then located within the first slot 20 and the second slot 22 at the same time. Relative rotational alignment between the rotor stack 16 and the rotor hub 14 is, therefore, achieved. Further, the rotor key 18 prevents relative rotation between the rotor hub 14 and the rotor stack 16 once assembled, as shown.

While the best modes for carrying out the invention have been described in detail, those familiar with the art to which this invention relates will recognize various alternative designs and embodiments for practicing the invention within the scope of the appended claims.

1. A electric motor comprising:
a rotor hub defining a first slot;
a rotor stack defining a second slot;
a rotor key having a shape generally corresponding to a cross-sectional shape of the first slot such that the rotor key is removably retained within the first slot; and
wherein the rotor key is inserted into the first slot on the rotor hub and into the second slot on the rotor stack.

2. The electric motor of claim 1, wherein the rotor key prevents relative rotation between the rotor stack and the rotor hub.

3. The electric motor of claim 1, wherein the rotor key is inserted in the first slot of the rotor hub prior to the rotor stack being mounted on the rotor hub.

4. The electric motor of claim 1, wherein the rotor hub defines a groove about the circumference of the rotor hub and wherein the first slot extends through the groove.

5. The electric motor of claim 1, wherein the rotor key has a generally trapezoidal shape, corresponding to a generally trapezoidal shape of the first slot defined by the rotor hub.

6. The electric motor of claim 1, wherein the rotor key is not formed by broaching the rotor stack.

7. The electric motor of claim 1, wherein the rotor key is retained within the first slot by staking the rotor hub.

8. A rotor assembly comprising:
a rotor hub defining a first slot having a generally dovetail cross-sectional shape;
a rotor key having a shape corresponding to the generally dovetail cross-sectional shape of the first slot; and
wherein the rotor key is inserted into the first slot on the rotor hub.

9. The rotor assembly of claim 8, further comprising a rotor stack defining a second slot, wherein the rotor key is inserted into second slot on the rotor stack.

10. The rotor assembly of claim 9, wherein the rotor key prevents relative rotation between the rotor stack and the rotor hub.

11. The rotor assembly of claim 9, wherein the rotor key is inserted in the first slot of the rotor hub prior to the rotor stack being mounted on the rotor hub.

12. The rotor assembly of claim 8, wherein the rotor hub defines a groove about the circumference of the rotor hub, and wherein the first slot extends through the groove.

13. The rotor assembly of claim 8, wherein the rotor key is retained within the first slot by staking the rotor hub.

14. A method of assembling a rotor assembly comprising:
inserting a rotor key having a trapezoidal shape in a first slot defined by a rotor hub, wherein the first slot has a dovetail shape corresponding to the shape of the rotor key such that the rotor key is retained within the first slot;
aligning a second slot defined by a rotor stack with the rotor key; and
mounting the rotor stack having a generally annular shape on the rotor hub, such that a portion of the rotor key is received within the second slot.

15. The method of claim 14, further comprising mounting a first end ring on the rotor hub prior to mounting the rotor stack and mounting a second end ring on the rotor hub after mounting the rotor stack.

16. The method of claim 14, wherein inserting the rotor key in the first slot further comprises sliding the rotor key in an axial direction within the rotor slot.

17. The method of claim 14, wherein inserting the rotor key further comprises stopping movement of the rotor key when the rotor key touches a base of the rotor hub.
